(19) United States
(12) Patent Application Publication
(10) Pub. No.: US 2007/0241586 A1
(43) Pub. Date: Oct. 18, 2007

(54) Weather panel apparatus for vehicles

(76) Inventor: Marcia M. Clark, Desoto, TX (US)

Correspondence Address: John M. Harrison, 2139 E. Bert Kouns, Shreveport, LA, 71105, US

(21) Appl. No.: 11/787,362

(22) Filed: Apr. 16, 2007

Related U.S. Application Data
(60) Provisional application No. 60/792,581, filed on Apr. 18, 2006.

(51) Int. Cl. B60J 1/20

(52) U.S. Cl. 296/152

(57) ABSTRACT

A weather panel apparatus for attachment to a vehicle, which apparatus includes a panel retraction frame having a typically spring-loaded roller rotatably mounted by means of roller pins in the frame and a flexible panel having one end attached to the roller and the opposite end of the panel fitted with one or more suction cups. The flexible panel is typically capable of flexure both in the lateral and longitudinal directions and may be extended from the panel retraction frame against spring tension and retracted in the panel retraction frame by spring action. The panel retraction frame is secured above the door frame inside a vehicle, typically by a loop-pile fastener, such that the flexible panel can be extended from the panel retraction frame and attached to the door window of the vehicle by means of the suction cup or cups. The flexible panel is extendable from the panel retraction frame when the suction cups are attached to the vehicle door window as the door is opened, to protect the occupant from inclement weather while entering and exiting the vehicle.

### CROSS-REFERENCE TO RELATED APPLICATIONS

This application claims the benefit of and incorporates by reference U.S. Provisional Patent Application Ser. No. 60/792,581, Filed Apr. 18, 2006.

### SUMMARY OF THE INVENTION

This invention relates to weather protection devices for vehicles and more particularly, to a weather panel apparatus which is characterized by a panel retraction frame secured to or near the interior door frame of a vehicle, typically by means of a loop-pile fastener. In a preferred embodiment, the panel retraction frame houses an internal, retractable, flexible panel deployed on a spring-loaded, rotatable drum or roller. The exposed edge of the flexible panel is typically fitted with one or more suction cups, clips or other devices for engaging the adjacent door window of the vehicle, such that opening of the door of the vehicle effects extension of the flexible panel from the panel retraction frame, typically against spring tension and facilitates protection of an occupant or occupants from inclement weather while the occupant(s) is entering and leaving the vehicle. The flexible panel deployment at or near the top of the vehicle and extending from the vehicle to the vehicle door window also prevents, or at least minimizes, water from entering the vehicle while the vehicle door is open and the occupant(s) is entering or leaving the vehicle.

### BRIEF DESCRIPTION OF THE DRAWING

The invention will be better understood by reference to the accompanying drawing, wherein:

FIG. 1 is a perspective view of a preferred embodiment of the panel element of the weather panel apparatus of this invention in deployed or extended configuration attached to a door window, with the door of the vehicle open;

FIG. 2 is an exploded view of the weather panel apparatus panel element illustrated in FIG. 1, more particularly illustrating a preferred panel retraction frame which is typically removably mounted on or near the inside door panel of the vehicle, typically by application of the loop and pile elements of a loop-pile fastener;

FIG. 3 is a perspective view of the weather panel apparatus illustrated in FIG. 2, with the panel retraction frame positioned in functional location inside the door panel of the vehicle and the flexible panel extended therefrom while attached to the door window of the open door of the vehicle by means of suction cups; and

FIG. 4 is a perspective view of the weather panel apparatus illustrated in FIG. 3, wherein a major portion of the flexible panel is retracted inside the panel retraction frame, typically responsive to spring action and closing of the door of the vehicle.

### DESCRIPTION OF THE PREFERRED EMBODIMENTS

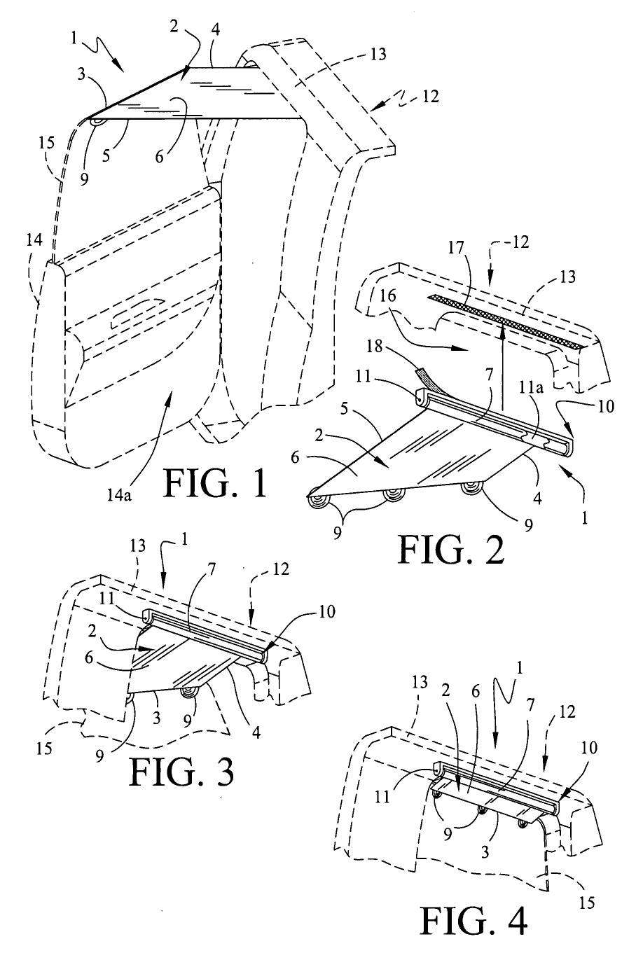

Referring to FIGS. 1-4 of the drawing, in a preferred embodiment the weather panel apparatus of this invention is generally illustrated by reference numeral 1. The weather panel apparatus 1 includes a flexible panel 2, which is wound on a frame roller or drum 11a (illustrated in FIG. 2). The frame roller 11a is rotatably mounted, typically under spring tension, inside a panel retraction frame 10 by means of frame roller pins 11, as illustrated in FIGS. 2-4 of the drawing. The flexible panel 2 is typically characterized by a rubber or resilient plastic material, which in one embodiment is capable of being deformed or stretched in both the lateral and longitudinal directions to define a protective cover or extended panel portion 6. The extended panel portion 6 is deployed over the doorway opening 14a of a vehicle 12 having an open door 14, hingedly mounted to a door frame 13 and fitted with a door window 15, as illustrated in phantom in FIG. 1. In a preferred embodiment the panel edge 3 of the flexible panel 4 is fitted with at least one, and preferably two or three, spaced-apart suction cups 9 which removably engage the door window 15, as illustrated in FIGS. 3 and 4 of the drawing. Moreover, the interior door frame 13 or a top area of the vehicle interior is typically fitted with a first loop-pile element 17, typically either the loop or pile element of a loop-pile fastener 16, with the opposite or second loop-pile element 18 of the loop pile fastener 16 attached to the top surface of the panel retraction frame 10. This design facilitates removably mounting the panel retraction frame 10 on the inside top surface of the door frame 13 or top interior area of the vehicle 12, as further illustrated in FIGS. 2-4 of the drawing. Accordingly, when the panel retraction frame 10 is so mounted inside the vehicle 12 and the suction cups 9 are attached to the exposed panel edge 3 of the flexible panel 2 in any convenient manner and secured to the door window 15, opening of the door 14 to define the door opening 14a (FIG. 1) effects an extension of the extended panel portion 6 of the flexible panel 2 outwardly from within the panel retraction frame 10 as the door opens (FIGS. 1 and 3). This extension of the flexible panel 2 facilitates stretching of the extended panel portion 6 such that the front panel margin 4 is shorter than the rear panel margin 5, due to the geometry of the door opening 14a created by the open door 14. Accordingly, the extended panel portion 6 of the flexible panel 2 provides protection from the elements, including rain, snow, sleet or hail, as the occupant or occupants (not illustrated) enter and leave the vehicle 12 through the door opening 14a.

Referring again to FIGS. 1 and 4 of the drawings, under circumstances where the door 14 and door window 15 are closed on the door frame 13 of the vehicle 12 after the occupant(s) has either entered the vehicle 12 or stepped from the vehicle 12 through the door opening 14a, the extended panel portion 6 is retracted inside the panel retraction frame 10 as the spring (not illustrated) in the spring-biased frame roller 11a rotates inside the panel retraction frame 10 on the frame roller pins 11. Accordingly, the extended panel portion 6 then becomes the retracted panel portion 7 rolled on the frame roller 11a, as illustrated in FIG. 4 of the drawings, when the door 14 and door window 15 are closed on the door frame 13 of the vehicle 12.

It will be appreciated by those skilled in the art that in one embodiment of the invention the flexible panel 2 can be constructed of any desirable material such as rubber or the like, which is capable of being stretched to define a rear panel margin 5 which is larger than the front panel margin 4 when the door 14 and door window 15 are opened on the door frame 13 of the vehicle 12, as illustrated in FIG. 1 of the drawings. Alternatively, the panel retraction frame 10 and the internal rotatable frame roller 11a can be designed such that the flexible panel 2 can be constructed of a less stretchable material such as plastic or the like, and still be rotatably received in the panel retraction frame 10, according to the knowledge of those skilled in the art. In any event, the design of the flexible panel 2 is such that extension of the flexible panel 2 from the panel retraction frame 10 to define the extended panel portion 6 covers the door opening 14a. This extension protects the occupant or occupants of the vehicle 12 from the elements during ingress and egress to and from the vehicle 12 through the door opening 14a, without the need for using an umbrella.

It will be further appreciated that the panel retraction frame 10 can be designed with a retraction button or tab (not illustrated) for activating an internal spring (not illustrated) that engages the frame roller 11a and automatically retracts the flexible panel 2 inside the panel retraction frame 10 on the rotating frame roller 11a. Other panel retraction frame designs can also be used to receive the flexible panel 2, including frame designs that have no frame roller 11a and may receive an inflexible panel or a panel of limited flexibility. Such a frame may be installed at the top of the vehicle interior beneath the ceiling cover and may be sized to accommodate a flexible or inflexible panel of selected length for extension over the door opening 14a when one end of the panel is attached to the door window 15.

Further in the alternative, the panel retraction frame 10 may be fitted with a fixed frame drum or shaft that receives a resilient curved panel such as a rolled plastic panel, having a “memory” that will curve and roll loosely around the fixed frame drum or shaft when the door 14 of the vehicle 12 is closed. Opening of the door 14 unwinds or partially unwinds the resilient plastic panel from the frame drum or shaft and allows the extended panel portion 6 to be deployed over the door opening 14a, as illustrated in FIG. 1.

While the preferred embodiments have been described above, it will be recognized and understood that various modifications may be made in the invention and the appended claims are intended to cover all such modifications which may fall within the spirit and scope of the invention.

Having described my invention with the particularity set forth above, what is claimed is:

1. A weather panel apparatus for a vehicle having a door and a door window provided in the door, comprising a panel retraction frame carried by the vehicle; a panel carried by said panel retraction frame for selective retraction in said panel retraction frame and extension from said panel retraction frame; and an engagement mechanism provided on said panel for engaging the door window, wherein said panel is extended from said panel retraction frame responsive to opening of the door and said panel is retracted in said panel retraction frame responsive to closing of the door on the vehicle.

2. The weather panel apparatus of claim 1 wherein said panel is spring-loaded in said panel retraction frame for retracting said panel in said panel retraction frame responsive to said closing of the door on the vehicle.

3. The weather panel apparatus of claim 1 wherein said panel is resilient and stretchable.

4. The weather panel apparatus of claim 3 wherein said panel is spring-loaded in said panel retraction frame for retracting said panel in said panel retraction frame responsive to said closing of the door on the vehicle.

5. The weather panel apparatus of claim 1 comprising a first element of a loop-pile fastener attached to the vehicle and a second element of said loop-pile fastener attached to said panel retraction frame, wherein said panel retraction frame is removably secured to the vehicle responsive to contact between said first element and said second element of said loop-pile fastener.

6. The weather panel apparatus of claim 5 wherein said panel is spring-loaded in said panel retraction frame for retracting said panel in said panel retraction frame responsive to said closing of the door on the vehicle.

7. The weather panel apparatus of claim 5 wherein said panel is resilient and stretchable.

8. The weather panel apparatus of claim 5 wherein:
(a) said panel is spring-loaded in said panel retraction frame for retracting said panel in said panel retraction frame responsive to said closing of the door on the vehicle; and
(b) said panel is resilient and stretchable.

9. A weather panel apparatus for a vehicle having a door and door window provided in the door, comprising a panel retraction frame carried by the vehicle; a drum or roller rotatably deployed in said panel retraction frame; a panel carried by said drum or roller for selective retraction in said panel retraction frame and extension from said panel retraction frame responsive to rotation of said drum or roller; and an engagement mechanism provided on said panel for engaging the door window of the door, wherein said panel is extended from said drum or roller responsive to opening of the door.

10. The weather panel apparatus of claim 9 wherein said drum or roller is spring-loaded in said panel retraction frame for retracting said panel in said panel retraction frame responsive to closing of the door on the vehicle.

11. The weather panel apparatus of claim 9 wherein said panel is resilient and stretchable.

12. The weather panel apparatus of claim 11 wherein said drum or roller is spring-loaded in said panel retraction frame for retracting said panel in said panel retraction frame responsive to closing of the door on the vehicle.

13. The weather panel apparatus of claim 9 comprising a first element of a loop-pile fastener attached to the vehicle and a second element of said loop-pile fastener attached to said panel retraction frame, wherein said panel retraction frame is removably secured to the vehicle responsive to contact between said first element and said second element of said loop-pile fastener.

14. The weather panel apparatus of claim 13 wherein said panel is resilient and stretchable.

15. The weather panel apparatus of claim 13 wherein said drum or roller is spring-loaded in said panel retraction frame for retracting said panel in said panel retraction frame responsive to closing of the door on the vehicle.

16. The weather panel apparatus of claim 13 wherein:
(a) said panel is resilient and stretchable; and
(b) said drum or roller is spring-loaded in said panel retraction frame for retracting said panel in said panel retraction frame responsive to closing of the door on the vehicle.

17. A weather panel apparatus for a vehicle having a door and door window provided in the door, comprising a panel retraction frame carried by the vehicle; a drum deployed in said panel retraction frame; a resilient panel engaging said drum; and an engagement mechanism provided on said resilient panel for engaging the door window, wherein said resilient panel is extended from said drum and said panel retraction frame responsive to opening of the door and said resilient panel is rolled on said drum and retracted in said panel retraction frame responsive to closing of the door.

18. The weather panel apparatus of claim 17 wherein said engagement mechanism comprises at least one suction cup.

19. The weather panel apparatus of claim 18 wherein said drum is rotatably deployed in said panel retraction frame and said one end of said panel is connected to said drum for retracting said panel in said panel retraction frame responsive to closing of the door on the vehicle and rotation of said drum in said panel rotation frame.

20. The weather panel apparatus of claim 17 comprising a first element of a loop-pile fastener attached to the vehicle and a second element of said loop-pile fastener attached to said panel retraction frame, wherein said panel retraction frame is removably secured to the vehicle responsive to contact between said first element and said second element of said loop-pile fastener.
